(19) United States
(12) Patent Application Publication
(10) Pub. No.: US 2008/0075257 A1
(43) Pub. Date: Mar. 27, 2008

(54) Telecommunication Network Screening of Telemarketer Messages

(76) Inventors: Steven Nguyen, Plano, TX (US); Venkatesh Raju, Richardson, TX (US)

Correspondence Address: CONLEY ROSE, P.C., 5601 GRANITE PARKWAY, SUITE 750, PLANO, TX, 75024, US

(21) Appl. No.: 11/737,490

(22) Filed: Apr. 19, 2007

Related U.S. Application Data
(60) Provisional application No. 60/826,637, filed on Sep. 22, 2006.

(51) Int. Cl. H04M 3/42

(52) U.S. Cl. 379/210.02

(57) ABSTRACT

A system and method for telecommunication network screening of telemarketer messages is provided. A telemarketer message intended for a telecommunication user is received. The telemarketer message and a telecommunication user preference are compared. The telemarketer message is blocked if the telecommunication user preference indicates that the telecommunication user does not want to receive the telemarketer message. The telemarketer message is provided to the telecommunication user if telecommunication user preference indicates that the telecommunication user wants to receive the telemarketer message.

### CROSS-REFERENCE TO RELATED APPLICATIONS

This application claims priority to U.S. Provisional Patent Application No. 60/826,637, entitled “System and Method of Screening Telemarketing Calls by a Telecommunications Network”, filed on Sep. 22, 2006, by Hai Duong Nguyen, et al., which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Telemarketing is a big industry that is rapidly growing, perhaps valued at over $250 billion annually and expected to reach $480 billion per year by 2009. Telemarketers have expanded their capacity to reach potential customers by sending messages such as electronic mail, text messages, instant messages, audio messages, video messages, and facsimiles to communication devices. A communication device can be a mobile phone, a wireless mobile device or telephone, a pager, a personal digital assistant, a portable computer, a tablet computer, a laptop computer, a desktop phone, a television, or any other well known type of communication device. Telemarketers have no way to determine which message content a communication device user is likely to respond favorably, or when the user wants to receive such messages. Therefore, many communication device users may react to receiving messages at inconvenient times by registering their communication devices for a “do not call” registry or setting an e-mail filter to screen all senders except for known senders, even though these same users would want to receive telemarketing messages at more convenient times. Furthermore, some users may react to receiving many messages in which they have no interest by registering their communication devices for the do not call registry even though these same users would want to receive telemarketing messages in which they are interested. The above described all-or-nothing screening of telemarketer messages does not satisfy the needs of either the communication device users or the needs of the telemarketers.

### SUMMARY

In one embodiment, a method for telecommunication network screening of telemarketer messages is provided. A telemarketer message intended for a telecommunication user is received. The telemarketer message and a telecommunication user preference are compared. The telemarketer message is blocked if the telecommunication user preference indicates that the telecommunication user does not want to receive the telemarketer message. The telemarketer message is provided to the telecommunication user if telecommunication user preference indicates that the telecommunication user wants to receive the telemarketer message.

In another embodiment, a system for telecommunication network screening of telemarketer messages is provided. The system includes a communication device, a telecommunication network, and a server. The server receives a telemarketer message via the telecommunication network for the communication device, compares the telemarketer message and a communication device preference. The server blocks the telemarketer message if the communication device preference indicates to block the telemarketer message, and provides the telemarketer message if the communication device preference indicates to provide the telemarketer message.

In yet another embodiment, a system for telecommunication network screening of telemarketer messages is provided. The system includes a communication device, a telemarketer, a telecommunication network, and a server. The server receives a telemarketer message from the telemarketer via the telecommunication network for the communication device, compares the telemarketer message and a communication device preference, blocks the telemarketer message if the communication device preference indicates to block the telemarketer message, and provides the telemarketer message if the communication device preference indicates to provide the telemarketer message.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 shows a system for telecommunication network screening of telemarketer messages according to an embodiment of the present disclosure.

FIG. 2 shows a flow chart of a method for telecommunication network screening of telemarketer messages according to an embodiment of the present disclosure.

FIG. 3 shows an illustrative wireless communications system.

FIG. 4 shows a block diagram of an illustrative communication device.

FIG. 5 shows a diagram of an illustrative software configuration for a communication device.

FIG. 6 illustrates an exemplary general-purpose computer system suitable for implementing the several embodiments of the disclosure.

### DETAILED DESCRIPTION OF THE PREFERRED EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Methods and systems for telecommunication network screening of telemarketer messages are provided. When a telecommunication network server receives a telemarketer message for a communication device via a telecommunication network, the server compares the message and communication device preferences. The telemarketer message intended for the communication device can be intercepted by the telecommunication network server or sent by a telemarketer to the telecommunication network server. The communication device preferences can be a profile entered by the user of the communication device specifically for the purposes of screening telemarketer messages or preferences for messages as determined by the server. The server can determine preferences by analyzing survey answers submitted by the communication device user and by analyzing patterns of rejection by the user of previously received telemarketer messages and other messages. The server determines information related to the message by processing information sent by the telemarketer for the purpose of screening messages or by analyzing the content of the message.

Based on the comparison of the message and the communication device preferences, the server blocks the message if the communication device preferences indicate that the user would not want the message. The server forwards the message to the communication device if the communication device preferences indicate that the user would want or be interested in the message. In some embodiments, the communication device preferences can specify the subjects for messages in which the user is interested, what times of the day and days of the week the user wants to receive messages, at which geographical locations the user want to receive messages, and from which telemarketers the user wants to receive messages. As used herein, the term subject or subjects should not be limited to particular fields in a message, such as a subject line of the message. Instead the term subject is intended to relate to the general nature or description of the message or desired messages and may include keywords or terms to assist in identifying matches between the message and the user preferences. If the communication device preferences indicate that the user does not want to receive the message when the server receives the message, the user can have the option of postponing receipt of the message or storing the message for subsequent retrieval. The server can notify the telemarketer, based on the communication device preferences, that it blocked the message. This allows the telemarketer to remove the communication device from its mailing list. This notification can result in the telemarketer sending messages more frequently to users that do not block the message, a higher rate of favorable responses to messages, and a more efficient allocation of telemarketer resources.

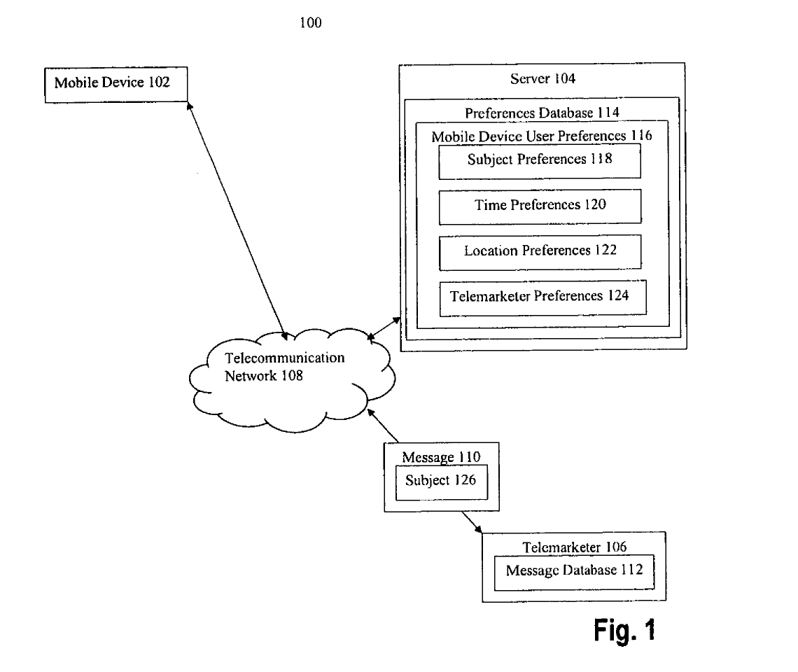

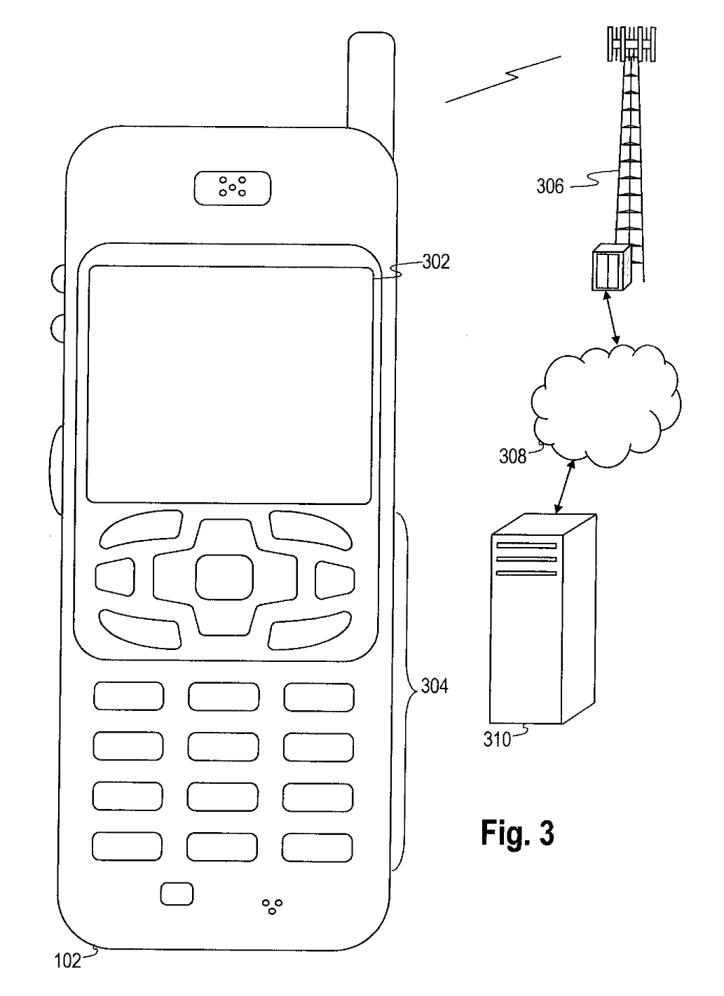

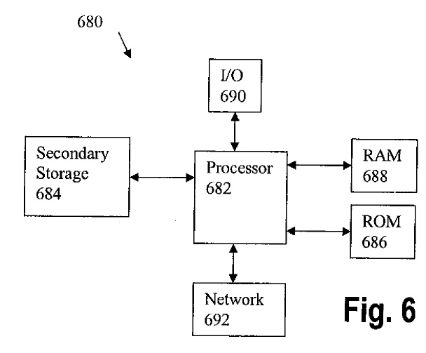

FIG. 1 depicts a system 100 for telecommunication network screening of telemarketer messages according to an embodiment of the present disclosure. The system 100 includes a communication device 102, which is described in more detail below with reference to FIGS. 3-5, a server 104, which is described in more detail below with reference to FIG. 6, a telemarketer 106, and a telecommunication network 108, by which the communication device 102, the server 104, and the telemarketer 106 communicate with each other. The telemarketer 106 sends a telemarketer message 110 for the user of the communication device 102 via the telecommunications network 108. The message 110 can be selected from a number of messages in a message database 112, which can also include a list of communication devices to send messages to. The system 100 shows only one communication device, one server, one telemarketer, and one message for the purposes of an illustrative example, but the system 100 may include any number of communication devices, servers, telemarketers, and messages. The telecommunication network 108 may be a wireless telecommunication network, a public switch telephone network, an internet, or other networks, or combinations thereof.

The server 104 for the telecommunication network 108 receives the message 110 intended for the communication device 102. The server 104 compares the message 110 to a preferences database 114, which includes communication device user preferences 116. The preferences database 114, or communication device preferences, can include preferences based on analysis by the server 104, or other systems, of survey answers by the user of the communication device 102, and based on analysis of rejections for messages received by the communication device 102. For example, if the server 104 reviews a survey answer in which the user of the communication device 102 indicates a plan to travel on a vacation within the next twelve months, the server 104 may set a preference for the user of the communication device 102 to receive messages related to staying at hotels. If the server 104 detects that the user of the communication device 102 has rejected telemarketer messages related to eating at a restaurant, the server 104 may set a preference for the user of the communication device 102 to not receive messages related to restaurants. Other information based on feedback from the user of the communication device 102 or user experience may be used.

The preferences database 114 can be based on inclusions and exclusions. For example, when the user of the communication device 102 indicates a plan to travel on a vacation within the next twelve months, the server 104 can set a preference for the user of the communication device 102 to receive specific messages, including messages related to staying at hotels. The preference to receive hotel messages can also imply a preference to block other messages that are not explicitly hotel messages, such as restaurant messages. Alternatively, the preference to receive hotel messages can result in receiving other messages that are not explicitly blocked. Continuing this example, when the server 104 detects that the user of the communication device 102 has rejected telemarketer messages related to eating at a restaurant, the server 104 sets a preference for the user of the communication device 102 to block messages related to eating at restaurants. The preference to block restaurant messages can also imply a preference to receive other messages that are not explicitly blocked, such as hotel messages.

The communication device user preferences 116, or telecommunication user preferences, include subject preferences 118, time preferences 120, location preferences 122, and telemarketer preferences 124. The user can enter a profile of the communication device preferences 116 in the communication device 102 for the purpose of screening telemarketer messages. The subject preferences 118 indicate the subject matter for which the user is interested in receiving telemarketer messages, such as messages for staying at a hotel. The telemarketer can include a subject 126 in the message 110 to assist the server 104 in identifying the subject matter of the message 110. Alternatively, the server 104 can analyze the message 110 to determine the subject 126 for the message 110. Similar to the preferences database 114, the subject preferences 118 can be based on inclusions and exclusions. The time preferences 120 indicate at which time and on what days the user wants to receive telemarketer messages, such as on weekends, on weekdays before 9:00 A.M., and on weekdays after 5:00 P.M. The location preferences 122 indicate at which geographical locations the user wants to receive telemarketer messages, such as when the user is at home. The telemarketer preferences 124 indicate from which telemarketers the user wants to receive telemarketer messages, such as hotel telemarketers. Similar to the subject preferences 118, the telemarketer preferences 124 can be based on inclusions and exclusions.

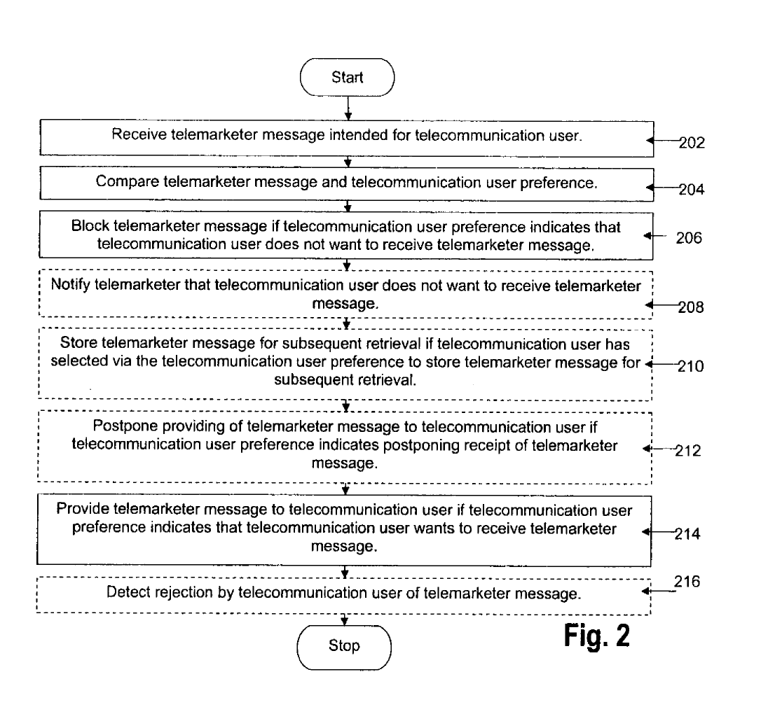

Turning now to FIG. 2, a flowchart of a method for telecommunication screening of telemarketer messages is depicted according to an embodiment of the present disclosure. Executing the method enables a telecommunication network server to screen telemarketer messages for communication devices based on communication device preferences.

In block 202, the server 104 receives the message 110 intended for a telecommunication user. For example, the server 104 receives the message 110 for the communication device 102 from the telemarketer 106 via the telecommunication network 108, such as a message advertising a stay at a hotel. The server 104 can determine information related to the message 110 by reviewing information provided by the telemarketer 106 for screening purposes, such as the subject 126 or other information that identifies the subject matter of the message 110, and the identity of the telemarketer 106 sending the message 110. Alternatively, the server 104 can determine information related to the message 110 by conducting a text analysis of the message 110. The server 104 can also determine the identity of the telemarketer 106 sending the message 110 by referencing the identifier for where the message 110 originated in an identifier database, such as a telephone number directory. Other registrations or identifications of telemarketers may be used.

In block 204, the server 104 compares the message 110 and a communication device preference. For example, the server 104 compares the message 110 and the communication device user preferences 116. The message 110 can be an advertisement for a stay at a hotel that was generated by a hotel telemarketer. The communication device user preferences 116 can include subject preferences 118 that indicate that the user of the communication device 102 wants to receive messages related to staying at hotels. Further, the communication device user preferences 116 may include telemarketer preferences 124 that indicate that the user of the communication device 102 wants to receive messages from such hotel telemarketers.

In block 206, the server 104 blocks the message 110 if the communication device user preferences indicate that the telecommunication user does not want to receive the message 110. For example, the communication device user preferences 116 include subject preferences 118 that indicate that the user of the communication device 102 does not want to receive messages related to restaurants. Alternatively, the telemarketer preferences 124 indicate that the user of the communication device 102 does not want to receive messages from restaurant telemarketers. For either of these examples, the server 104 blocks the message 110 if the message 110 is an advertisement for eating at a restaurant that was generated by a restaurant telemarketer.

In block 208, the server 104 can optionally notify the telemarketer 108 that the telecommunication user does not want to receive the message 110. For example, the server 104 notifies a restaurant telemarketer that the user of the communication device 102 does not want to receive any message related to eating at a restaurant. The restaurant telemarketer can remove the user of the communication device 102 from a send list such that the telemarketer sends messages more frequently to the users of other communication devices that might be interested. By removing this user, future telemarketer messages may be received more favorably, and a more efficient allocation of telemarketer resources may be achieved.

In block 210, the server 104 postpones providing of the message 110 to the telecommunication user if the communication device preferences want to postpone receipt of the message 110. For example, the server 104 postpones providing of the message 110 to the user of the communication device 102 if the user is at work and the location preferences 122 indicate that the user does not want to receive messages while the user is at work. This may be determined by a global positioning satellite (GPS) sensor on the communication device 102 that determines the position of the communication device 102 and identifies the location as the workplace of the user. The server 104 can wait until the GPS sensor on the communication device 102 determines the position of the communication device 102 is no longer at the work location of the user and then provide the postponed message to the user of the communication device 102.

In block 212, the server 104 stores the message 110, such as on the communication device 102, the server 104, or elsewhere, for subsequent retrieval if the telecommunication user has selected via the telecommunication user preferences to store the message 110 for subsequent retrieval. For example, the server 104 may store the message 110 to the communication device 102 for subsequent retrieval if the user of the communication device 102 has selected, via the time preferences 116, to store the message 110 for subsequent retrieval depending on the time the message 110 is received. For example, the time preferences 116 indicate to store the message 110 for subsequent retrieval if the server 104 receives the message 110 during normal business hours and the server has received the message at 11:00 A.M. on a Wednesday. The user of the communication device 102 can then subsequently retrieve the message 110 from a storage device and review messages at a more convenient time.

In block 214, the server 104 provides the message 110 to the telecommunication user if the communication device preferences indicate that the telecommunication user wants to receive the message 110. For example, the server 104 can provide the message 110 to the communication device 102 if the subject preferences 118 indicate that the user of the communication device 102 wants to receive messages related to staying at hotels and the subject 126 of the message 110 is hotels. The server 104 can also provide the message 110 to the communication device 102 if the hotel message is sent at a time when the time preferences 120 indicate that the user wants to receive messages. Additionally, the server 104 can provide the message 110 to the communication device 102 if the communication device 102 is at a geographic location where the location preferences 122 indicate that the user wants to receive messages. Furthermore, the server 104 can provide the message 110 to the communication device 102 if the telemarketer preferences 124 indicate that the user wants to receive messages from hotel telemarketers. However, the server 104 can block the message 110 if the message 110 is specifically designed for users within a geographic region, such as a discount that expires within hours for eating at a restaurant located in Los Angles, and the GPS sensor on the communication device 102 determines the position of the communication device 102 which is normally in Los Angeles is currently in New York.

In block 216, the server 104 detects rejection by the telecommunication user of the message 110. For example, the server 104 detects rejection of a restaurant message by the user of the communication device 102. The rejection may then be used to update the preferences database 114, which could result in the server 104 blocking subsequent restaurant messages for the communication device 102. The server 104 can determine to block restaurant messages based on the rejection of a single restaurant message or the server 104 can make this determination based on multiple rejections of restaurant messages. The server 104 can also update the preferences database 114 by analyzing rejection patterns from the user of the communication device 102 rejecting messages based on the subject of the message 110. Other reasons for rejection may include the specific telemarketer that sent the message 110, the time that the message 110 is sent, and the geographical location of the communication device 102 when the message is sent. The communication device 102 can offer options for the user to specify the reason for rejecting the message 110. Other information, such as demographic data, may be used for determining how the telemarketer messages should be handled.

FIG. 3 shows a wireless communications system including the communication device 102. FIG. 3 depicts the communication device 102, which is operable for implementing aspects of the present disclosure, but the present disclosure should not be limited to these implementations. Though illustrated as a mobile phone, the communication device 102 may take various forms including a wireless communication device, a pager, a personal digital assistant (PDA), a portable computer, a tablet computer, a laptop computer, a digital camera, a digital music player, a digital calculator, a desktop telephone, a television, and an electronic key fob for keyless entry. Many suitable communication devices combine some or all of these functions. In some embodiments of the present disclosure, the communication device 102 is not a general-purpose computing device like a notebook or tablet computer, but rather is a special-purpose communications device such as a mobile phone, pager, or PDA.

The communication device 102 includes a display 302 and a touch-sensitive surface or keys 304 for input by a user. The communication device 102 may present options for the user to select, controls for the user to actuate, and/or cursors or other indicators for the user to direct, including options such as entry of the communication device user preferences 116. The communication device 102 may further accept data entry from the user, including numbers to dial or various parameter values for configuring the operation of the communication device 102. The communication device 102 may further execute one or more software or firmware applications in response to user commands, such as a command to reject the receipt of the message 110. These applications may configure the communication device 102 to perform various customized functions in response to user interaction.

Among the various applications executable by the communication device 102 are a web browser, which enables the display 302 to show a web page. The web page is obtained via wireless communications with a cell tower 306, a wireless network access node, or another wireless communications network or system. The cell tower 306 (or wireless network access node) is coupled to a wired network 308, such as the Internet. Via the wireless link and the wired network, the communication device 102 has access to information on various servers, such as a content server 310. The content server 310 may provide content that may be shown on the display 302.

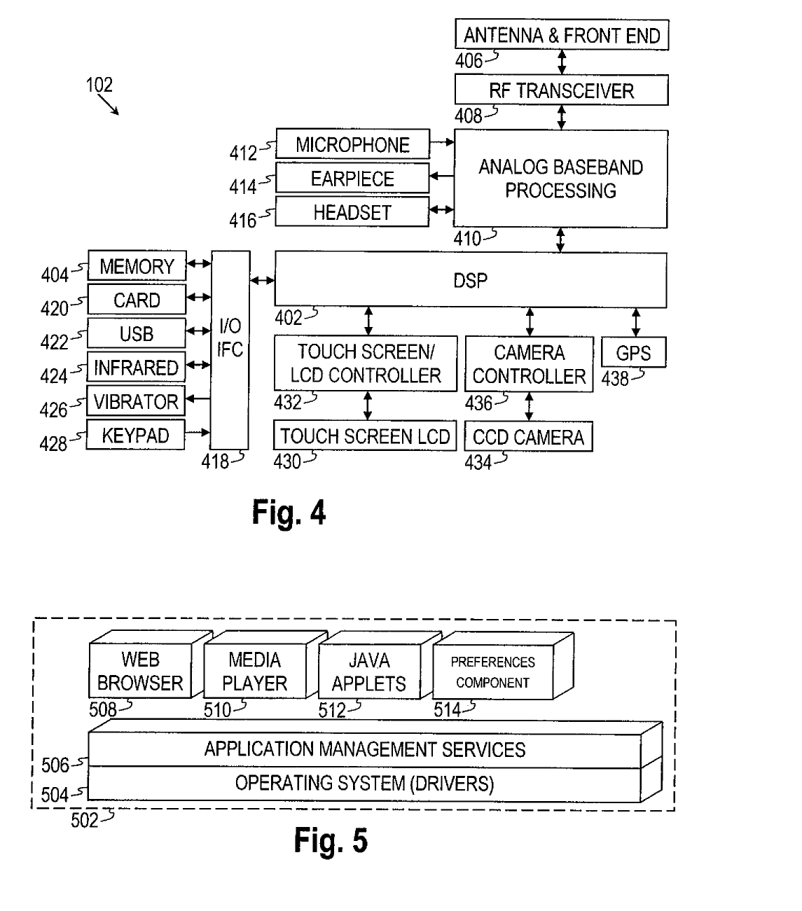

FIG. 4 shows a block diagram of the communication device 102. The communication device 102 includes a digital signal processor (DSP) 402 and a memory 404. As shown, the communication device 102 may further include an antenna and front end unit 406, a radio frequency (RF) transceiver 408, an analog baseband processing unit 410, a microphone 412, an earpiece speaker 414, a headset port 416, an input/output interface 418, a removable memory card 420, a universal serial bus (USB) port 422, an infrared port 424, a vibrator 426, a keypad 428, a touch screen liquid crystal display (LCD) with a touch sensitive surface 430, a touch screen/LCD controller 432, a charge-coupled device (CCD) camera 434, a camera controller 436, and a global positioning system (GPS) sensor 438.

The DSP 402 or some other form of controller or central processing unit operates to control the various components of the communication device 102 in accordance with embedded software or firmware stored in memory 404. In addition to the embedded software or firmware, the DSP 402 may execute other applications stored in the memory 404 or made available via information carrier media such as portable data storage media like the removable memory card 420 or via wired or wireless network communications. The application software may comprise a compiled set of machine-readable instructions that configure the DSP 402 to provide the desired functionality, or the application software may be high-level software instructions to be processed by an interpreter or compiler to indirectly configure the DSP 402.

The antenna and front end unit 406 may be provided to convert between wireless signals and electrical signals, enabling the communication device 102 to send and receive information from a cellular network or some other available wireless communications network. The RF transceiver 408 provides frequency shifting, converting received RF signals to baseband and converting baseband transmit signals to RF. The analog baseband processing unit 410 may provide channel equalization and signal demodulation to extract information from received signals, may modulate information to create transmit signals, and may provide analog filtering for audio signals. To that end, the analog baseband processing unit 410 may have ports for connecting to the built-in microphone 412 and the earpiece speaker 414 that enable the communication device 102 to be used as a cell phone. The analog baseband processing unit 410 may further include a port for connecting to a headset or other hands-free microphone and speaker configuration.

The DSP 402 may send and receive digital communications with a wireless network via the analog baseband processing unit 410. In some embodiments, these digital communications may provide Internet connectivity, enabling a user to gain access to content on the Internet and to send and receive e-mail or text messages, including messages such as the message 110. The input/output interface 418 interconnects the DSP 402 and various memories and interfaces. The memory 404 and the removable memory card 420 may provide software and data to configure the operation of the DSP 402. Among the interfaces may be the USB interface 422 and the infrared port 424. The USB interface 422 may enable the communication device 102 to function as a peripheral device to exchange information with a personal computer or other computer system. The infrared port 424 and other optional ports such as a Bluetooth interface or an IEEE 802.11 compliant wireless interface may enable the communication device 102 to communicate wirelessly with other nearby communication devices and/or wireless base stations.

The input/output interface 418 may further connect the DSP 402 to the vibrator 426 that, when triggered, causes the communication device 102 to vibrate. The vibrator 426 may serve as a mechanism for silently alerting the user to any of various events such as an incoming call, a new text message such as the message 110, and an appointment reminder.

The keypad 428 couples to the DSP 402 via the interface 418 to provide one mechanism for the user to make selections, enter information, and otherwise provide input to the communication device 102, including information entered such as the communication device user preferences 116. Another input mechanism may be the touch screen LCD 430, which may also display text and/or graphics to the user. The touch screen LCD controller 432 couples the DSP 402 to the touch screen LCD 430.

The CCD camera 434 enables the communication device 102 to take digital pictures. The DSP 402 communicates with the CCD camera 434 via the camera controller 436. The GPS sensor 438 is coupled to the DSP 402 to decode global positioning system signals, thereby enabling the communication device 102 to determine its position. Various other peripherals may also be included to provide additional functions, e.g., radio and television reception.

FIG. 5 illustrates a software environment 502 that may be implemented by the DSP 402. The DSP 402 executes operating system drivers 504 that provide a platform from which the rest of the software operates The operating system drivers 504 provide drivers for the communication device hardware with standardized interfaces that are accessible to application software. The operating system drivers 504 include application management services (“AMS”) 506 that transfer control between applications running on the communication device 102. Also shown in FIG. 5 are a web browser application 508, a media player application 510, Java applets 512, and a preferences component 514. The web browser application 508 configures the communication device 102 to operate as a web browser, allowing a user to enter information into forms and select links to retrieve and view web pages. The media player application 510 configures the communication device 102 to retrieve and play audio or audiovisual media. The Java applets 512 configure the communication device 102 to provide games, utilities, and other functionality. The preferences component 514 is capable of promoting the selection of the communication device user preferences 116 and the rejection of the received message 110. In some embodiments, the preferences component 514 might be a firmware component, a hardware component, or a combination of software, firmware, and/or hardware.

The system described above may be implemented on any general-purpose computer with sufficient processing power, memory resources, and network throughput capability to handle the necessary workload placed upon it. FIG. 6 illustrates a typical, general-purpose computer system suitable for implementing one or more embodiments disclosed herein. The computer system 680, such as the server 104, includes a processor 682 (which may be referred to as a central processor unit or CPU) that is in communication with memory devices including secondary storage 684, read only memory (ROM) 686, random access memory (RAM) 688, input/output (I/O) 690 devices, and network connectivity devices 692. The processor may be implemented as one or more CPU chips.

The secondary storage 684 is typically comprised of one or more disk drives or tape drives and is used for non-volatile storage of data and as an over-flow data storage device if the RAM 688 is not large enough to hold all working data. Secondary storage 684 may be used to store programs that are loaded into the RAM 688 when such programs are selected for execution. The ROM 686 is used to store instructions and perhaps data that are read during program execution. The ROM 686 is a non-volatile memory device that typically has a small memory capacity relative to the larger memory capacity of secondary storage. The RAM 688 is used to store volatile data and perhaps to store instructions. Access to both the ROM 686 and the RAM 688 is typically faster than to the secondary storage 684.

The I/O 690 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 692 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 692 devices may enable the processor 682 to communicate with an Internet or one or more intranets. With such a network connection, it is contemplated that the processor 682 might receive information from the network, or might output information to the network in the course of performing the above-described method steps, including information such as the message 110. Such information, which is often represented as a sequence of instructions to be executed using the processor 682, may be received from and outputted to the network, for example, in the form of a computer data signal embodied in a carrier wave

Such information, which may include data or instructions to be executed using the processor 682 for example, may be received from and outputted to the network, for example, in the form of a computer data baseband signal or signal embodied in a carrier wave. The baseband signal or signal embodied in the carrier wave generated by the network connectivity 692 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 682 executes instructions, codes, computer programs, scripts that it accesses from hard disk, floppy disk, optical disk (these various disk based systems may all be considered the secondary storage 684), the ROM 686, the RAM 688, or the network connectivity devices 692.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for screening telemarketer messages, comprising:
receiving a telemarketer message intended for a telecommunication user;
comparing the telemarketer message and a telecommunication user preference;
blocking the telemarketer message if the telecommunication user preference indicates that the telecommunication user does not want to receive the telemarketer message; and
providing the telemarketer message to the telecommunication user if telecommunication user preference indicates that the telecommunication user wants to receive the telemarketer message.

2. The method of claim 1, further comprising postponing the providing of the telemarketer message to the telecommunication user if the telecommunication user preference indicates postponing the receipt of the telemarketer message.

3. The method of claim 1, wherein the telecommunication user preference and the telemarketer message both include a subject, and wherein if the subjects of both the telecommunication user preference and the telemarketer message match then providing the telemarketer message to the telecommunication user.

4. The method of claim 1, wherein the telecommunication user preference includes a time preference that indicates when the telecommunication user wants to receive the telemarketer message.

5. The method of claim 1, wherein the telecommunication user preference includes a location preference that indicates at which geographical locations the telecommunication user wants to receive the telemarketer message.

6. The method of claim 1, wherein the telecommunication user preference includes a telemarketer preference that indicates for which telemarketers the telecommunication user wants to receive the telemarketer message.

7. The method of claim 1, wherein the telemarketer message is selected from a group consisting of electronic mail, a text message, an instant message, an audio message, a video message, multimedia message (MMS), and a facsimile.

8. The method of claim 1, further comprising storing the telemarketer message for subsequent retrieval if the telecommunication user has selected via the telecommunication user preference to store the telemarketer message for subsequent retrieval.

9. The method of claim 1, wherein the telemarketer message comprises at least one of information provided by a telemarketer for screening purposes and a telemarketer identity for the telemarketer message.

10. The method of claim 1, further comprising extracting a subject matter of the telemarketer message to compare with user preferences.

11. The method of claim 1, further comprising notifying a telemarketer that the telecommunication user does not want to receive the telemarketer message

12. The method of claim 1, further comprising detecting a rejection by the telecommunication user of the telemarketer message to update the telecommunication user preference.

13. The method of claim 1, wherein the telecommunication user preference is based on a profile submitted by the telecommunication user.

14. A system for screening telemarketing messages, comprising:
a communication device;
a telecommunication network; and
a server to receive a telemarketer message via the telecommunication network for the communication device, the server to compare the telemarketer message and a communication device preference and to block the telemarketer message if the communication device preference indicates to block the telemarketer message, and to provide the telemarketer message if the communication device preference indicates to provide the telemarketer message.

15. The system of claim 14, wherein the communication device preference is one of preferences selected by a user of the communication device and information provided by a telecommunication network provider.

16. The system of claim 14, wherein the communication device preference and the telemarketer message both include a subject, and wherein if the subjects of both the communication device preference and the telemarketer message match then the server provides the telemarketer message to the communication device.

17. The system of claim 14, wherein the communication device preference includes a time preference that indicates when the user of the communication device wants to receive the telemarketer message.

18. The system of claim 14, wherein the communication device preference includes a location preference that indicates at which geographical locations the user of the communication device wants to receive the telemarketer message.

19. The system of claim 14, wherein each communication device is selected from a group consisting of a telephone, a mobile phone, a wireless mobile device, a pager, a personal digital assistant, a portable computer, a tablet computer, a laptop computer, a digital camera, a digital music player, a digital calculator, an electronic key fob for keyless entry, a desktop phone, a television, and a communication device.

20. A system for screening of telemarketing messages, comprising:
a communication device;
a telemarketer system;
a telecommunication network; and
a server to receive a telemarketer message from the telemarketer system via the telecommunication network for the communication device, the server to compare the telemarketer message and a communication device preference and to block the telemarketer message if the communication device preference indicates to block the telemarketer message, and to provide the telemarketer message if the communication device preference indicates to provide the telemarketer message.
